(19) United States
(12) Patent Application Publication
(10) Pub. No.: US 2026/0163296 A1
(43) Pub. Date: Jun. 11, 2026

(54) SEPARABLE CONNECTORS FOR ELECTRICAL TRANSFORMERS

(71) Applicant: ABB SCHWEIZ AG, Baden (CH)

(72) Inventors: Robert Fong, Bethlehem, PA (US); Stanley S. Szyszko, Wall, NJ (US); George Richard Hydock, Mount Bethel, PA (US)

(21) Appl. No.: 18/970,221

(22) Filed: Dec. 5, 2024

(51) Int. Cl. H01R 13/52; H01R 4/18; H01R 4/30

(52) U.S. Cl. CPC H01R 13/5205; H01R 4/183; H01R 4/30; H01R 13/5213; H01R 2201/22

(57) ABSTRACT

Devices may include an electrically insulating interface body including a first end portion, a second, opposite end portion, and an intermediate portion therebetween. An electrically conductive connector may be positioned at least partially within the interface body and may extend from the first end portion toward the second end portion. An opening may be in the intermediate portion of the interface body. The connector may include a first coupling feature configured to electrically couple to a conductive cable, a second coupling feature configured to electrically couple to a transformer electrical connector post, and an electrical connection point between the first coupling feature and the second coupling feature. The opening of the interface body may expose the electrical connection point. Various other related devices, systems, and methods may employ such features.

### BACKGROUND

Electrical connectors for transformers are often designed to handle high power densities and are built with materials that enhance conductivity and resist environmental degradation. Electrical connectors for transformers can be constructed to withstand mechanical vibrations, weather, thermal cycles, and electrical stresses without failure. Ease of installation and maintenance reduces downtime and ensures secure and reliable electrical connections. Separable connectors are a type of electrical connectors that allow maintenance personnel to install and remove cables that input power to and/or output power from the transformers, while sealing around the cable to protect the connection from degradation and/or faults.

### SUMMARY

In some aspects, the techniques described herein relate to a device, including: an electrically insulating interface body, including: a first end portion; a second, opposite end portion; an intermediate portion between the first end portion and second end portion; and an opening in the intermediate portion; and an electrically conductive connector positioned at least partially within the interface body and extending from the first end portion toward the second end portion of the interface body, the connector including: a first coupling feature configured to electrically couple to a conductive cable; a second coupling feature configured to electrically couple to a transformer electrical connector post; and an electrical connection point between the first coupling feature and the second coupling feature, wherein the opening of the interface body exposes the electrical connection point.

In some aspects, the techniques described herein relate to a device, wherein the first coupling feature is configured to electrically couple to the conductive cable via a spade connector coupled to the conductive cable.

In some aspects, the techniques described herein relate to a device, wherein the electrical connection point includes a conductive post extending radially outward from the electrically conductive connector.

In some aspects, the techniques described herein relate to a device, further including an insulating plug configured to cover the opening of the interface body.

In some aspects, the techniques described herein relate to a device, wherein the opening includes a tapered inner surface.

In some aspects, the techniques described herein relate to a device, wherein the opening includes a cylindrical protrusion extending radially outward from the intermediate portion of the interface body.

In some aspects, the techniques described herein relate to a device, wherein the second coupling feature includes a threaded bolt configured to engage with a threaded hole in the transformer electrical connector post.

In some aspects, the techniques described herein relate to a device, wherein the second end portion of the interface body includes a tapered inner surface complementary to a transformer bushing surrounding the transformer electrical connector post.

In some aspects, the techniques described herein relate to a device, wherein the electrically insulating interface body includes a synthetic rubber material.

In some aspects, the techniques described herein relate to a device, including: a first electrically conductive connector for physically and electrically connecting to an exposed end portion of an insulated cable; and an interface assembly for physically and electrically connecting the first electrically conductive connector to a transformer electrical connector post, the interface assembly including: an electrically insulating interface body including a first end portion proximate the first electrically conductive connector, a second, opposite end portion configured for coupling to the transformer electrical connector post, and an intermediate portion between the first end portion and second end portion, the intermediate portion including an opening; and a second electrically conductive connector positioned at least partially within the interface body and configured for connecting to the first electrically conductive connector and to the transformer electrical connector post, wherein the opening of the interface body exposes an electrical connection point of the second electrically conductive connector.

In some aspects, the techniques described herein relate to a device, wherein the first electrically conductive connector is configured to be crimped to the exposed end portion of the insulated cable.

In some aspects, the techniques described herein relate to a device, wherein the first electrically conductive connector includes a spade connector for connecting to the second electrically conductive connector with a bolt or pin.

In some aspects, the techniques described herein relate to a device, wherein the connection point of the second electrically conductive connector includes a protrusion extending into the opening of the interface body.

In some aspects, the techniques described herein relate to a device, further including an insulating plug configured to cover the opening of the interface body.

In some aspects, the techniques described herein relate to a device, further including a cable adapter shaped and sized to fit over the insulated cable with the exposed end portion.

In some aspects, the techniques described herein relate to a device, further including an electrically insulating outer housing shaped and sized to fit over the cable adapter and the first electrically conductive connector.

In some aspects, the techniques described herein relate to a device, wherein the outer housing is configured to couple to the interface body to form a water-tight seal with the interface body.

In some aspects, the techniques described herein relate to a device, including: a first electrically conductive connector for physically and electrically connecting to an exposed end portion of an insulated cable; a cable adapter shaped and sized to fit over the insulated cable with the exposed end portion; an interface assembly for physically and electrically connecting the first electrically conductive connector to a transformer electrical connector post, the interface assembly including: an electrically insulating interface body including a first end portion proximate the first electrically conductive connector, a second, opposite end portion configured for coupling to the transformer electrical connector post, and an intermediate portion between the first end portion and second end portion, the intermediate portion including an opening; and a second electrically conductive connector positioned at least partially within the interface body and configured for connecting to the first electrically conductive connector and to the transformer electrical connector post, wherein the opening of the interface body exposes an electrical connection point of the second electrically conductive connector; and an electrically insulating outer housing shaped and sized to fit over the cable adapter and the first electrically conductive connector and to couple to the interface assembly.

In some aspects, the techniques described herein relate to a device, wherein: the opening is defined by an extension of the interface body extending radially outward; and the electrical connection point includes a protrusion extending into the opening of the interface body.

In some aspects, the techniques described herein relate to a device, wherein the second end portion of the interface body includes a tapered inner surface shaped and sized for abutting against a transformer bushing surrounding the transformer electrical connector post.

### BRIEF DESCRIPTION OF THE DRAWINGS

FIG. 1 is an exploded side view of an electrical connector device, according to at least one embodiment of the present disclosure.

FIG. 2 is a cross-sectional, exploded side view of the electrical connector device of FIG. 1.

FIG. 3 is a front perspective view of an electrical connector device of FIG. 1.

FIG. 4 is a back perspective view of the electrical connector device of FIG. 1.

FIG. 5 is an exploded side view of the electrical connector device of FIG. 1.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

The present disclosure provides detailed descriptions of devices, such as separable connectors for transformers. As will be explained in greater detail below, embodiments of the present disclosure may include devices (e.g., separable connectors) that include an electrically insulating interface body including a first end portion, a second, opposite end portion, and an intermediate portion therebetween. An electrically conductive connector may be positioned at least partially within the interface body and may extend from the first end portion toward the second end portion. An opening may be in the intermediate portion of the interface body. The connector may include a first coupling feature configured to electrically couple to a conductive cable, a second coupling feature configured to electrically couple to a transformer electrical connector post, and an electrical connection point between the first coupling feature and the second coupling feature. The opening of the interface body may expose the electrical connection point. Such separable connectors may facilitate grounding or other electrical access to a transformer connection.

Features from any of the embodiments described herein may be used in combination with one another in accordance with the general principles described herein. These and other embodiments, features, and advantages will be more fully understood upon reading the following detailed description in conjunction with the accompanying drawings and claims.

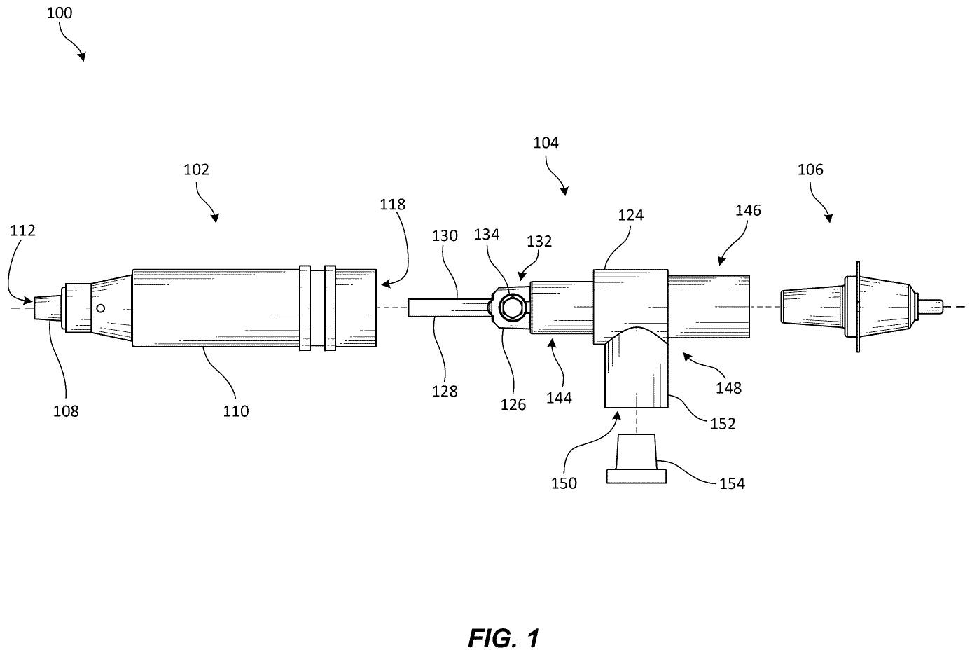

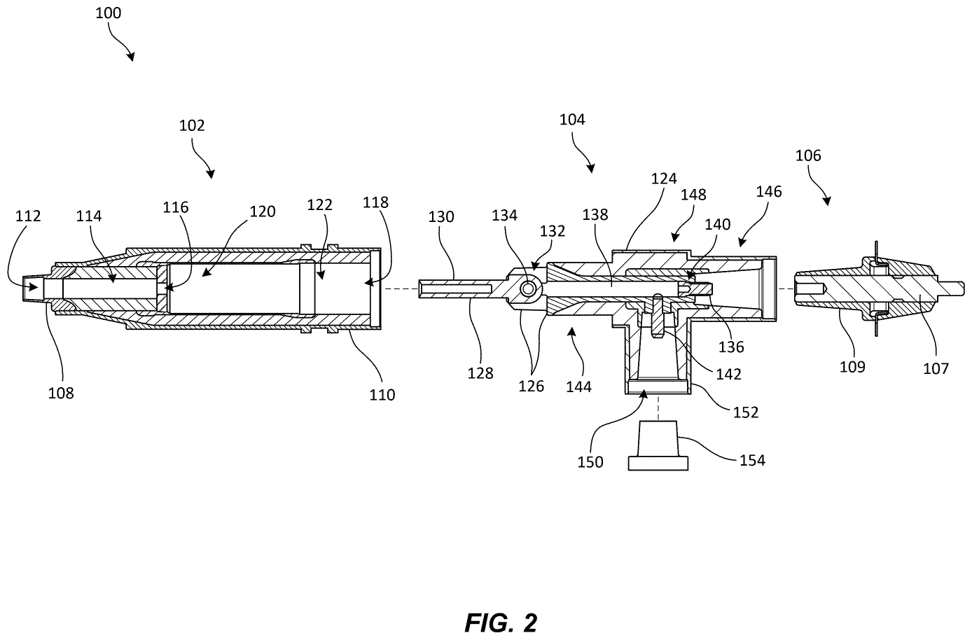

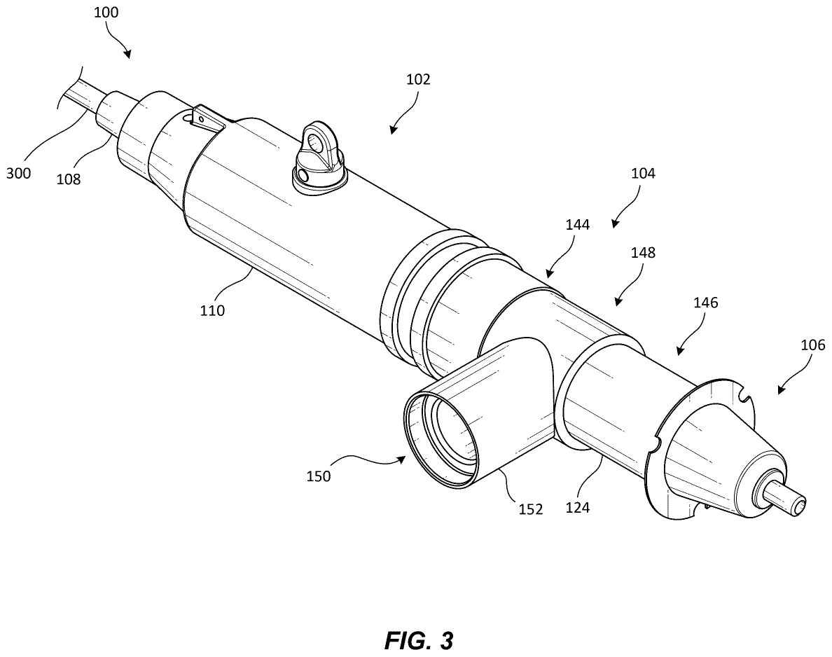

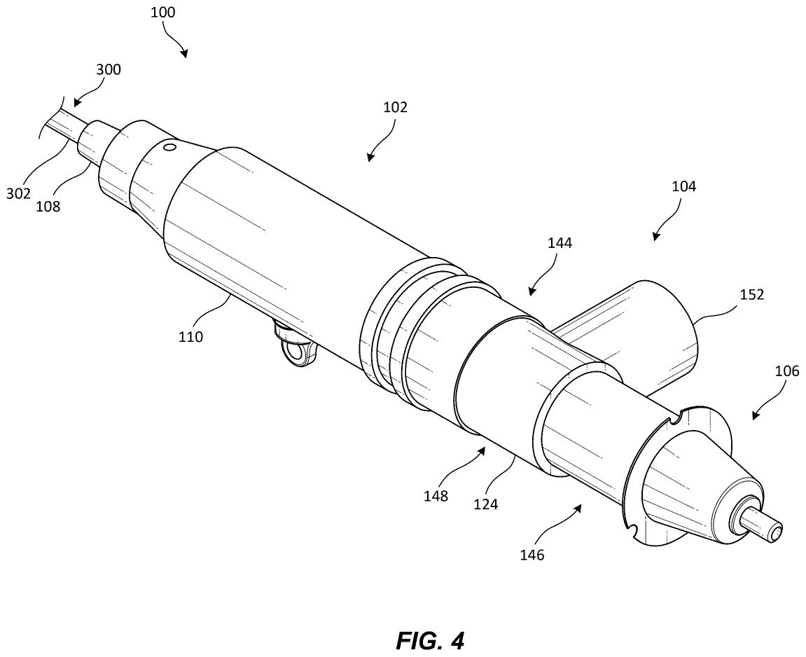

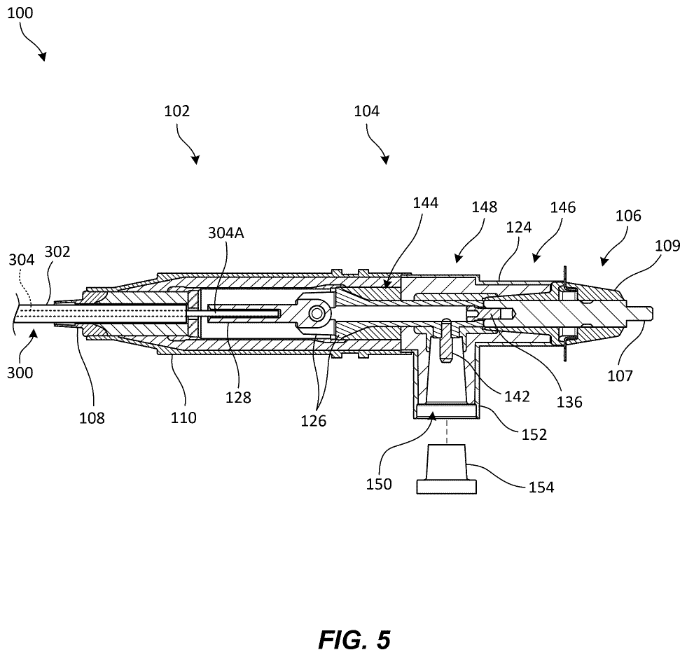

FIG. 1 is an exploded side view of an electrical connector device 100, according to at least one embodiment of the present disclosure. FIG. 2 is a cross-sectional, exploded side view of the electrical connector device 100 of FIG. 1. FIG. 3 is a front perspective view of an electrical connector device 100 of FIG. 1. FIG. 4 is a back perspective view of the electrical connector device 100 of FIG. 1. FIG. 5 is an exploded side view of the electrical connector device 100 of FIG. 1.

Referring to FIGS. 1 and 2, the electrical connector device 100 may include a cable connection assembly 102 and an interface assembly 104 configured for electrically connecting a conductive cable to a transformer connector 106.

The cable connection assembly 102 may include a cable adapter 108 and an electrically insulating outer housing 110. The cable adapter 108 may include an inner bore 112 sized to fit around a cable. The size of the cable adapter 108 and inner bore 112 may be selected based on the size of the cable to be used with the electrical connector device 100. For example, as illustrated in FIG. 2, a first portion 114 of the inner bore 112 may be sized to fit around (e.g., snugly fit around) an insulating covering of the cable and a second portion 116 of the inner bore 112 may be sized to fit around (e.g., snugly fit around) a conductor of the cable (e.g., a portion of the cable striped of the insulating covering).

The electrically insulating outer housing 110 of the electrical connector device 100 may include a central bore 118. A first longitudinal end 120 of the central bore 118 may be shaped and sized to fit radially around at least a portion of the cable adapter 108 and to form a water-tight seal around the cable adapter 108. A second longitudinal end 122 of the central bore 118 may be shaped and sized to fit radially around at least a portion of the interface assembly 104 and to form a water-tight seal around the interface assembly 104.

The cable adapter 108 and the electrically insulating outer housing 110 may be formed of one or more electrically insulating materials, such as including a rubber material (e.g., a synthetic rubber material such as ethylene propylene monomer (EPM) rubber, ethylene propylene diene monomer (EPDM) rubber, etc.), a polymer material (polyvinyl chloride (PVC), nylon, etc.), or the like.

The interface assembly 104 may include an electrically insulating interface body 124 and an electrically conductive connector 126 positioned at least partially within the electrically insulating interface body 124. A first coupling feature 128 may be configured to electrically couple to the cable (e.g., to an exposed end portion of a conductor of the cable).

The first coupling feature 128 may be configured for physically and electrically connecting to an exposed end portion of a cable (e.g., a conductor of an insulated cable). For example, the first coupling feature 128 may include a cable receiver 130 and an eyelet 132. In some examples, the cable receiver 130 may be or include an elongated metal piece with a bore therein for receiving the exposed end portion of the cable. The cable receiver 130 may be configured for crimping to secure the first coupling feature 128 to the exposed end portion of the cable. The eyelet 132 may be configured for physically and electrically connecting the first coupling feature 128 to the electrically conductive connector 126, such as with a bolt 134 or pin. For example, the first coupling feature 128 may be or include a spade connector.

At least a portion of the electrically conductive connector 126 may be encased within the electrically insulating interface body 124. The electrically conductive connector 126 may form a physical and electrical connection between the first coupling feature 128 (and ultimately the cable connected to the first coupling feature 128) and the transformer connector 106 (and ultimately a transformer associated with the transformer connector 106). For example, the electrically conductive connector 126 may connect to the first coupling feature 128 with the bolt 134, as noted above. At an opposing end, the electrically conductive connector 126 may include a second coupling feature 136 configured to connect to a transformer electrical connector post 107 of the transformer connector 106. For example, the second coupling feature 136 may be or include another bolt positioned at least partially within a central passage 138 through the electrically conductive connector 126. The central passage 138 may enable access to the other bolt for tightening or loosening the other bolt relative to the transformer electrical connector post 107, such as with a screwdriver, hex key, or the like. An inner ledge 140 at an end of the central passage 138 may interface with a head of the other bolt.

In some examples, the first coupling feature 128 may be considered a first electrically conductive connector and the electrically conductive connector 126 may be considered a second electrically conductive connector.

As illustrated in FIG. 2, an electrical connection point 142 may be positioned along the electrically conductive connector 126 between the first coupling feature 128 and the second coupling feature 136. For example, the electrical connection point 142 may be or include a protrusion, such as a bolt or pin, extending radially outward from, and coupled to, the electrically conductive connector 126. The electrical connection point 142 may be configured for providing electrical access to the electrically conductive connector 126, such as for grounding and/or testing a connection between the cable and the transformer connector 106, which may ultimately be used to ground and/or test an electrical line of a transformer associated with the transformer connector 106.

The electrically insulating interface body 124 may include a first end portion 144 from which the electrically conductive connector 126 may extend and a second end portion 146 configured for coupling to the transformer connector 106. An intermediate portion 148 of the electrically insulating interface body 124 may be between the first end portion 144 and the second end portion 146. The intermediate portion 148 may include an opening 150, which may expose the electrical connection point 142. For example, the opening 150 may be defined by an inner surface of an extension 152 of the electrically insulating interface body 124 extending radially outward. For example, the extension 152 may be in the form of a cylindrical protrusion that extends from the electrically insulating interface body 124. In some embodiments, the electrical connection point 142 may extend into the opening 150 of the electrically insulating interface body 124. In some examples, the inner surface of the extension 152 defining the opening 150 may be tapered, such as to receive a grounding-aid device.

The electrical connector device 100 may also include an insulating plug 154 shaped and sized for covering the opening 150 of the electrically insulating interface body 124. In some examples, the insulating plug 154 may form a water-tight seal over or within the opening 150. While the insulating plug 154 is shown in FIGS. 1 and 2 as a separate piece, the present disclosure is not so limited. In additional examples, the insulating plug 154 may be an integral part of, or may be connected to, the electrically insulating interface body 124, such as the extension 152 of the electrically insulating interface body 124.

The electrically insulating interface body 124 and the insulating plug 154 may be formed of one or more electrically insulating materials, such as including a rubber material (e.g., a synthetic rubber material such as ethylene propylene monomer (EPM) rubber, ethylene propylene diene monomer (EPDM) rubber, etc.), a polymer material (polyvinyl chloride (PVC), nylon, etc.), or the like.

As mentioned above, the second end portion 146 of the electrically insulating interface body 124 may be configured for coupling to the transformer connector 106. For example, the second end portion 146 may include a tapered inner surface complementary to a tapered outer surface of a transformer bushing 109 of the transformer connector 106. The transformer bushing 109 may include an insulating material surrounding the transformer electrical connector post 107.

In some embodiments, the transformer connector 106 may be part of, or may be connected to, an existing transformer. In additional embodiments, the transformer connector 106 may be part of, or may be connected to (e.g., pre-assembled to), the electrical connector device 100 (e.g., the interface assembly 104 of the electrical connector device 100) separate from an existing transformer.

FIGS. 3-5 illustrate the electrical connector device 100 in an assembled state and coupling a cable 300 to the transformer connector 106. The cable adapter 108 may be positioned over the cable 300 to form a water-tight seal around an exterior of an outer sheath 302 of the cable 300. For example, the outer sheath 302 may include an insulating material (e.g., a polyvinyl chloride (PVC) material) surrounding a conductor 304 (FIG. 5) of the cable 300.

At one end, the electrically insulating outer housing 110 may be positioned over a portion of the cable adapter 108 to form a water-tight seal around an exterior of the cable adapter 108. At an opposite end, the electrically insulating outer housing 110 may be positioned over a portion (e.g., the first end portion 144) of the interface assembly 104 to form a water-tight seal around an exterior of the interface assembly 104.

The interface assembly 104 may be coupled to the transformer connector 106, such as at the second end portion 146 of the interface assembly 104. As noted above, the electrically insulating interface body 124 of the interface assembly 104 may include the extension 152 along the intermediate portion 148 of the interface assembly 104. An inner portion of the extension 152 may define the opening 150 for exposing and connecting to the electrical connection point 142 of the electrically conductive connector 126 (FIG. 5).

As illustrated in FIG. 5, an exposed end portion 304A (e.g., stripped of the outer sheath 302) of the conductor 304 of the cable 300 may be coupled to the first coupling feature 128 of the interface assembly 104. For example, the first coupling feature 128 may be crimped to the exposed end portion 304A of the conductor 304. The conductor 304 may include a solid (e.g., single strand) conductor 304 or a multi-stranded conductor 304.

The electrically conductive connector 126 may electrically connect the first coupling feature 128 to the transformer electrical connector post 107 via the second coupling feature 136. For example, the second coupling feature 136 may be a bolt that screws into a threaded hole in the transformer electrical connector post 107. When the electrical connector device 100 is coupled to the transformer connector 106, the tapered inner surface of the interface assembly 104 may abut against the transformer bushing 109 surrounding the transformer electrical connector post 107 to form a water-tight seal around the transformer connector 106.

Accordingly, the present disclosure includes devices, such as separable connectors for electrical transformers, that may be improved in some respects over existing solutions. For example, some embodiments of the present disclosure may provide a grounding or other electrical access point (e.g., an electrical connection point 142) along an intermediate portion of the connector. In some examples, an interface body thereof may be added or otherwise implemented to existing separable connectors as a retrofit option.

The following example embodiments are also included in the present disclosure.

Example 1. A device, including: an electrically insulating interface body, including: a first end portion; a second, opposite end portion; an intermediate portion between the first end portion and second end portion; and an opening in the intermediate portion; and an electrically conductive connector positioned at least partially within the interface body and extending from the first end portion toward the second end portion of the interface body, the connector including: a first coupling feature configured to electrically couple to a conductive cable; a second coupling feature configured to electrically couple to a transformer electrical connector post; and an electrical connection point between the first coupling feature and the second coupling feature, wherein the opening of the interface body exposes the electrical connection point.

Example 2. The device of Example 1, wherein the first coupling feature is configured to electrically couple to the conductive cable via a spade connector coupled to the conductive cable.

Example 3. The device of Example 1 or Example 2, wherein the electrical connection point includes a conductive post extending radially outward from the electrically conductive connector.

Example 4. The device of any one of Examples 1 through 3, further including an insulating plug configured to cover the opening of the interface body.

Example 5. The device of any one of Examples 1 through 4, wherein the opening includes a tapered inner surface.

Example 6. The device of any one of Examples 1 through 5, wherein the opening includes a cylindrical protrusion extending radially outward from the intermediate portion of the interface body.

Example 7. The device of any one of Examples 1 through 6, wherein the second coupling feature includes a threaded bolt configured to engage with a threaded hole in the transformer electrical connector post.

Example 8. The device of any one of Examples 1 through 7, wherein the second end portion of the interface body includes a tapered inner surface complementary to a transformer bushing surrounding the transformer electrical connector post.

Example 9. The device of any one of Examples 1 through 8, wherein the electrically insulating interface body includes a synthetic rubber material.

Example 10. A device, including: a first electrically conductive connector for physically and electrically connecting to an exposed end portion of an insulated cable; and an interface assembly for physically and electrically connecting the first electrically conductive connector to a transformer electrical connector post, the interface assembly including: an electrically insulating interface body including a first end portion proximate the first electrically conductive connector, a second, opposite end portion configured for coupling to the transformer electrical connector post, and an intermediate portion between the first end portion and second end portion, the intermediate portion including an opening; and a second electrically conductive connector positioned at least partially within the interface body and configured for connecting to the first electrically conductive connector and to the transformer electrical connector post, wherein the opening of the interface body exposes an electrical connection point of the second electrically conductive connector.

Example 11. The device of Example 10, wherein the first electrically conductive connector is configured to be crimped to the exposed end portion of the insulated cable.

Example 12. The device of Example 10 or Example 11, wherein the first electrically conductive connector includes a spade connector for connecting to the second electrically conductive connector with a bolt or pin.

Example 13. The device of any one of Examples 10 through 12, wherein the connection point of the second electrically conductive connector includes a protrusion extending into the opening of the interface body.

Example 14. The device of any one of Examples 10 through 13, further including an insulating plug configured to cover the opening of the interface body.

Example 15. The device of any one of Examples 10 through 14, further including a cable adapter shaped and sized to fit over the insulated cable with the exposed end portion.

Example 16. The device of Example 15, further including an electrically insulating outer housing shaped and sized to fit over the cable adapter and the first electrically conductive connector.

Example 17. The device of Example 16, wherein the outer housing is configured to couple to the interface body to form a water-tight seal with the interface body.

Example 18. A device, including: a first electrically conductive connector for physically and electrically connecting to an exposed end portion of an insulated cable; a cable adapter shaped and sized to fit over the insulated cable with the exposed end portion; an interface assembly for physically and electrically connecting the first electrically conductive connector to a transformer electrical connector post, the interface assembly including: an electrically insulating interface body including a first end portion proximate the first electrically conductive connector, a second, opposite end portion configured for coupling to the transformer electrical connector post, and an intermediate portion between the first end portion and second end portion, the intermediate portion including an opening; and a second electrically conductive connector positioned at least partially within the interface body and configured for connecting to the first electrically conductive connector and to the transformer electrical connector post, wherein the opening of the interface body exposes an electrical connection point of the second electrically conductive connector; and an electrically insulating outer housing shaped and sized to fit over the cable adapter and the first electrically conductive connector and to couple to the interface assembly.

Example 19. The device of Example 18, wherein: the opening is defined by an extension of the interface body extending radially outward; and the electrical connection point includes a protrusion extending into the opening of the interface body.

Example 20. The device of Example 18 or Example 19, wherein the second end portion of the interface body includes a tapered inner surface shaped and sized for abutting against a transformer bushing surrounding the transformer electrical connector post.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device, comprising:
an electrically insulating interface body, comprising:
a first end portion;
a second, opposite end portion;
an intermediate portion between the first end portion and second end portion; and
an opening in the intermediate portion; and
an electrically conductive connector positioned at least partially within the interface body and extending from the first end portion toward the second end portion of the interface body, the connector comprising:
a first coupling feature configured to electrically couple to a conductive cable;
a second coupling feature configured to electrically couple to a transformer electrical connector post; and
an electrical connection point between the first coupling feature and the second coupling feature, wherein the opening of the interface body exposes the electrical connection point.

2. The device of claim 1, wherein the first coupling feature is configured to electrically couple to the conductive cable via a spade connector coupled to the conductive cable.

3. The device of claim 1, wherein the electrical connection point comprises a conductive post extending radially outward from the electrically conductive connector.

4. The device of claim 1, further comprising an insulating plug configured to cover the opening of the interface body.

5. The device of claim 1, wherein the opening comprises a tapered inner surface.

6. The device of claim 1, wherein the opening comprises a cylindrical protrusion extending radially outward from the intermediate portion of the interface body.

7. The device of claim 1, wherein the second coupling feature comprises a threaded bolt configured to engage with a threaded hole in the transformer electrical connector post.

8. The device of claim 1, wherein the second end portion of the interface body comprises a tapered inner surface complementary to a transformer bushing surrounding the transformer electrical connector post.

9. The device of claim 1, wherein the electrically insulating interface body comprises a synthetic rubber material.

10. A device, comprising:
a first electrically conductive connector for physically and electrically connecting to an exposed end portion of an insulated cable; and
an interface assembly for physically and electrically connecting the first electrically conductive connector to a transformer electrical connector post, the interface assembly comprising:
an electrically insulating interface body including a first end portion proximate the first electrically conductive connector, a second, opposite end portion configured for coupling to the transformer electrical connector post, and an intermediate portion between the first end portion and second end portion, the intermediate portion including an opening; and
a second electrically conductive connector positioned at least partially within the interface body and configured for connecting to the first electrically conductive connector and to the transformer electrical connector post, wherein the opening of the interface body exposes an electrical connection point of the second electrically conductive connector.

11. The device of claim 10, wherein the first electrically conductive connector is configured to be crimped to the exposed end portion of the insulated cable.

12. The device of claim 10, wherein the first electrically conductive connector comprises a spade connector for connecting to the second electrically conductive connector with a bolt or pin.

13. The device of claim 10, wherein the connection point of the second electrically conductive connector comprises a protrusion extending into the opening of the interface body.

14. The device of claim 10, further comprising an insulating plug configured to cover the opening of the interface body.

15. The device of claim 10, further comprising a cable adapter shaped and sized to fit over the insulated cable with the exposed end portion.

16. The device of claim 15, further comprising an electrically insulating outer housing shaped and sized to fit over the cable adapter and the first electrically conductive connector.

17. The device of claim 16, wherein the outer housing is configured to couple to the interface body to form a water-tight seal with the interface body

18. A device, comprising:
a first electrically conductive connector for physically and electrically connecting to an exposed end portion of an insulated cable;
a cable adapter shaped and sized to fit over the insulated cable with the exposed end portion;
an interface assembly for physically and electrically connecting the first electrically conductive connector to a transformer electrical connector post, the interface assembly comprising:
an electrically insulating interface body including a first end portion proximate the first electrically conductive connector, a second, opposite end portion configured for coupling to the transformer electrical connector post, and an intermediate portion between the first end portion and second end portion, the intermediate portion including an opening; and
a second electrically conductive connector positioned at least partially within the interface body and configured for connecting to the first electrically conductive connector and to the transformer electrical connector post, wherein the opening of the interface body exposes an electrical connection point of the second electrically conductive connector; and
an electrically insulating outer housing shaped and sized to fit over the cable adapter and the first electrically conductive connector and to couple to the interface assembly.

19. The device of claim 18, wherein:
the opening is defined by an extension of the interface body extending radially outward; and
the electrical connection point comprises a protrusion extending into the opening of the interface body.

20. The device of claim 18, wherein the second end portion of the interface body comprises a tapered inner surface shaped and sized for abutting against a transformer bushing surrounding the transformer electrical connector post.
